(19) United States
(12) Patent Application Publication
(10) Pub. No.: US 2015/0090319 A1
(43) Pub. Date: Apr. 2, 2015

(54) SOLAR CELL MODULE, PRODUCTION METHOD FOR SOLAR CELL MODULE, SUPPORT STRUCTURE FOR SOLAR CELL MODULE, AND SOLAR POWER GENERATION SYSTEM

(71) Applicant: SHARP KABUSHIKI KAISHA, Osaka-shi, Osaka (JP)

(72) Inventors: Kazuhiro Mizuo, Osaka-shi (JP); Takashi Hayakawa, Osaka-shi (JP)

(21) Appl. No.: 14/394,619

(22) PCT Filed: Apr. 1, 2013
(86) PCT No.: PCT/JP2013/059993

§ 371 Date: Oct. 15, 2014

(30) Foreign Application Priority Data
Apr. 18, 2012 (JP) 2012-095082

(51) Int. Cl. H01L 31/042; F16M 11/02; F16M 13/02; H01L 31/18

(52) U.S. Cl. CPC H02S 20/00; H01L 31/18; F16M 11/02; F16M 13/02
USPC 136/251; 438/66; 248/121

(57) ABSTRACT

A solar cell module includes a solar cell module body (11), an adhesive (30), and a support rail (12) bonded and fixed by the adhesive (30) to a back surface of the solar cell module body (11), in which a spacer member (40) for ensuring the thickness of the adhesive (30) is arranged between the back surface of the solar cell module body (11) and an adhesive surface (12a1) of the support rail (12).

### TECHNICAL FIELD

The present invention relates to a solar cell module, production method for solar cell module, support structure for solar cell module, and solar power generation system for photoelectric conversion of sunlight.

### BACKGROUND ART

An example of a conventional solar power generation system is described in PTL 1.

In this solar power generation system, a plurality of concrete-made mountings each in an elongated shape are arranged in parallel with each other with a constant space, and ends on one side in the longer direction of two adjacent mountings are coupled with a first coupling member and ends on the other side are coupled with a second coupling member. Between mountings, each solar cell module is mounted over the first coupling member and the second coupling member. Also, ends of adjacent solar cell modules are arranged in a step formed at each of both ends of the upper surface of each mounting, and a holding member is mounted and fixed onto the upper surface of the mounting. With this, the ends of adjacent solar cell modules are pressed and supported by the holding member from above.

Also, another conventional solar power generation system has been also suggested, which has a structure in which a support member is bonded to a back surface side of a solar cell module body with an adhesive member and this support member is used also as a member for mounting on a mounting (for example, refer to PTL 2).

### CITATION LIST

### Patent Literatures

PTL 1: Japanese Unexamined Patent Application Publication No. 2011-165795

PTL 2: Japanese Unexamined Patent Application Publication No. 2011-222930

### SUMMARY OF INVENTION

### Technical Problem

However, when the support member is bonded to the back surface of the solar cell module body with the adhesive member, it is difficult to keep the thickness of the adhesive member at a constant thickness by simply coating the back surface of the solar cell module body with the adhesive member and pressing and bonding the adhesive surface of the support member onto this coated surface. There is a possibility that adhesive strength cannot be sufficiently obtained at a thin portion.

In particular, when the support structure between the support member and the solar cell module body is established only by bonding, it is extremely important to ensure adhesive strength between the back surface of the solar cell module body and the adhesive surface of the support member over the full length in one direction.

The present invention was made to solve this problem, and an object is to provide a solar cell module, production method for solar cell module, support structure for solar cell module, and solar power generation system capable of sufficiently ensuring adhesive strength between a solar cell module body and a support member with an adhesive member.

### Solution to Problem

To solve the problem described above, a solar cell module of the present invention is a solar cell module including a solar cell module body, an adhesive member, and a support member bonded and fixed by the adhesive member to a back surface of the solar cell module body, and a spacer member for ensuring a thickness of the adhesive member is arranged between the back surface of the solar cell module body and an adhesive surface of the support member. Also, the solar cell module of the present invention is configured in a manner such that a plurality of the support members in a long shape are arranged in parallel with each other with a predetermined space, and a plurality of the solar cell module bodies are provided as being bridged over each of the support members to be bonded and fixed to each of the support members.

According to the present invention, by arranging the spacer member between the back surface of the solar cell module body and the adhesive surface of the support member, the thickness of the adhesive member can be ensured. Therefore, adhesive strength between the support member and the solar cell module body can be increased, and a favorable bonding state can be kept.

Also, in the solar cell module of the present invention, the spacer members are configured to be arranged with respect to the solar cell module body at a plurality of locations in a longer direction of the support member.

According to this structure, by arranging the spacer members at the plurality of locations with respect to one solar cell module body (that is, by arranging two or more spacer members), a gap between the support member and the back surface of the solar cell module body can be kept at a constant width by the plurality of spacer members. Therefore, the thickness of the adhesive member for coating can also be kept at a constant thickness.

Furthermore, in the solar cell module of the present invention, the spacer members are configured to be arranged at both ends of the solar cell module body.

According to this structure, by arranging the spacer members at both ends of one solar cell module body, the thickness of the adhesive member can be kept in balance from end to end of the spacer members.

Still further, in the solar cell module of the present invention, the spacer member may be further configured to be arranged at one or plurality of locations along the longer direction between the both ends of the solar cell module body.

According to this structure, by arranging a spacer member at a location other than the both ends, the thickness of the adhesive member can be approximately kept uniform over the full length of the support member. Therefore, adhesive strength can also be approximately uniformly ensured over the full length of the support member.

Still further, in the solar cell module of the present invention, a double-sided adhesive tape can be used as the spacer member. By using a double-sided adhesive tape as the spacer member, the operation of arranging the spacer member can be facilitated.

Still further, in the solar cell module of the present invention, the adhesive member may be provided so as to run over from one side or both sides of the adhesive surface of the support member along the longer direction.

As such, by providing the adhesive member as running over from one side or both sides of the adhesive surface of the support member along the longer direction, when this solar cell module is mounted on a tilted mount surface of a mounting as being tilted, at least the side where the adhesive member runs over is arranged on an upper tilted side. With this, water droplets attached and flowing on the back surface of the solar cell module can be prevented from immersing between the back surface of the solar cell module and the adhesive surface of the support member.

Still further, in the solar cell module of the present invention, the structure may be such that a hole penetrating through a surface opposite to the adhesive surface is provided in the adhesive surface of the support member.

According to this structure, by providing the hole, the bonding state can be checked by visual inspection from the hole after the support member is bonded to the back surface of the solar cell module.

Still further, in the solar cell module of the present invention, the structure is such that the adhesive member is provided so as to be immersed into the hole and cover at least an inner circumferential surface of the hole.

When a plated steel plate is used as the support member, a hole is formed by hole processing, and rust tends to occur from a hole processed portion. However, by covering the inner circumferential surface of the hole with the adhesive member, the occurrence of rust can be prevented.

Still further, in the solar cell module of the present invention, the holes are provided at a plurality of locations along the longer direction of the support member. By providing the holes at the plurality of locations along the longer direction of the support member, whether the bonding state is good or bad can be checked at the plurality of locations in the longer direction. Therefore, it is possible to easily check whether the adhesive member has been favorably bonded over the full length of the support member.

A solar cell module production method of the present invention is a method of producing a solar cell module including a solar cell module body, a support member supporting the solar cell module body, and an adhesive member bonding and fixing the support member onto a back surface of the solar cell module body, the method including a step of arranging a spacer member for ensuring a thickness of the adhesive member on either one of an adhesive region on a back surface side of the solar cell module body where the support member is bonded and an adhesive region of the adhesive surface of the support member, a coating step of coating, with the adhesive member, either one of the adhesive region on the back surface side of the solar cell module body where the support member is bonded and the adhesive region of the adhesive surface of the support member, and a laminating step of laminating the adhesive region on the back surface side of the solar cell module body and the adhesive region of the support member to bond the solar cell module body and the support member together.

According to the present invention, by arranging the spacer member, the thickness of the adhesive member can be kept at a constant thickness defined by the spacer member. Therefore, adhesive strength can be increased over the full length in one direction.

Also, according to the solar cell module production method of the present invention, in the coating step, the adhesive member may be provided so as to run over from one side or both sides of the adhesive surface of the support member along the longer direction.

According to the present invention, by providing the adhesive member as running over from one side or both sides of the adhesive surface of the support member along the longer direction, when this solar cell module is installed on a tilted mount surface of the mounting as being tilted, at least the side where the adhesive member runs over is arranged on an upper tilted side. With this, water droplets attached and flowing on the back surface of the solar cell module can be prevented from immersing between the back surface of the solar cell module and the adhesive surface of the support member.

Also, a support structure for a solar cell module according to the present invention is a support structure for each of the above-structured solar cell modules, and the structure includes a mounting where an end of the support member bonded to the solar cell module is mounted, and a fixing part which fixes the end to the mounting.

According to the present invention, by mounting the support member on the back surface of the solar cell module in advance, the operation of mounting the solar cell module on the mounting can be facilitated.

Furthermore, a support structure for a solar cell module according to the present invention is a solar cell module support structure for supporting a plurality of the above-described solar cell modules aligned thereon, and the structure includes a mounting where ends which are adjacent to each other of the support member of the solar cell modules which are adjacent to each other are mounted, and a fixing part which fixes the ends which are adjacent to each other to the mounting.

According to the present invention, by mounting the plurality of solar cell modules on the support member in advance, mounting the solar cell modules on a mount part can be facilitated.

Also, a solar power generation system of the present invention is constructed by using the support structure for the solar cell module of each of the above structures. According to the solar power generation system of the present invention, operations and effects similar to those of the above-described solar cell module support structure.

### Advantageous Effects of Invention

Since the present invention is constructed as described above, by arranging the spacer member between the back surface of the solar cell module body and the adhesive surface of the support member, the thickness of the adhesive member can be ensured. Therefore, adhesive strength between the support member and the solar cell module body can be increased, and a favorable bonding state can be kept.

### BRIEF DESCRIPTION OF DRAWINGS

FIG. 1 is a schematic perspective view depicting an entire structure of a solar cell system in the state in which a solar cell module having a solar cell module body integrally assembled thereto is disposed on a mounting, according to an embodiment of the present invention.

FIG. 2 is a schematic left side view of a solar power generation system A depicted in FIG. 1.

FIG. 3 is a schematic exploded perspective view depicting the state before the solar cell module is installed on the mounting.

FIG. 4 is a schematic perspective view of a sub-unit viewed from a light-receiving-surface side.

FIG. 5 is a schematic perspective view of the sub-unit viewed from a back surface side opposite to the light-receiving surface.

FIG. 6 is a schematic perspective view depicting one solar cell module body as exploded, with the sub-unit viewed from the back surface side.

FIG. 7 is a schematic perspective view depicting a schematic structure of a support rail.

FIG. 8 is a schematic sectional view depicting a schematic structure of the support rail.

FIG. 9 is a plan view of the sub-unit in which two support rails are arranged in parallel with each other with a predetermined space and three solar cell module bodies are arranged thereabove so as to be aligned almost without a space.

FIG. 10 is a schematic sectional view along a C-C line of FIG. 9.

FIG. 11 is a schematic perspective view depicting an example of a mounting device for use in an arranging process.

FIG. 12 is a schematic side view of the mounting device.

FIG. 13 is a schematic sectional view along a D-D line of FIG. 11.

FIG. 14 is a schematic perspective view depicting an example of a coating device provided to the mounting device for use in a coating process.

FIG. 15 is a schematic perspective view depicting the state in which the solar cell module bodies are bonded to the support rails in a bonding process.

FIG. 16 is a sectional view along an E-E line of FIG. 15.

FIG. 17 is a sectional view along an F-F line of FIG. 15.

FIG. 18 is a sectional view along the F-F line of FIG. 15.

FIG. 19 is a sectional perspective view depicting another example of structure of the support rail.

FIG. 20 is a sectional view along a G-G line of FIG. 19.

FIG. 21 is a sectional view of the support rail of the other example of structure bonded to the back surface of the solar cell module body.

FIG. 22 is a schematic perspective view of the state in which a receiving part is mounted on and fixed to a longitudinal bar, when viewed from diagonally above.

FIG. 23 is a schematic perspective view of the state in which the receiving part is mounted on and fixed to the longitudinal bar, when viewed from diagonally below.

FIG. 24 is a schematic sectional view along an H1-H1 line in FIG. 22 and FIG. 23 depicting the state in which the receiving part is mounted on and fixed to the longitudinal bar.

FIG. 25 is a schematic exploded perspective view of the state in which installation ends of support rails that are adjacent to each other in a lateral direction with respect to the receiving part fixed to the longitudinal bar abut on each other to be fixed with a fixture, when viewed from diagonally above.

FIG. 26 is a schematic sectional view along an H2-H2 line in FIG. 22 and FIG. 23 depicting the state in which the installation ends of the support rails that are adjacent to each other in the lateral direction with respect to the receiving part fixed to the longitudinal bar abut on each other to be fixed with the fixture.

### DESCRIPTION OF EMBODIMENTS

An embodiment according to the present invention is described below with reference to the drawings. Note that the following embodiment is an example obtained by embodying the present invention, and is not characterized to restrict the technical scope of the present invention.

<Description of Entire Structure of Solar Power Generation System>

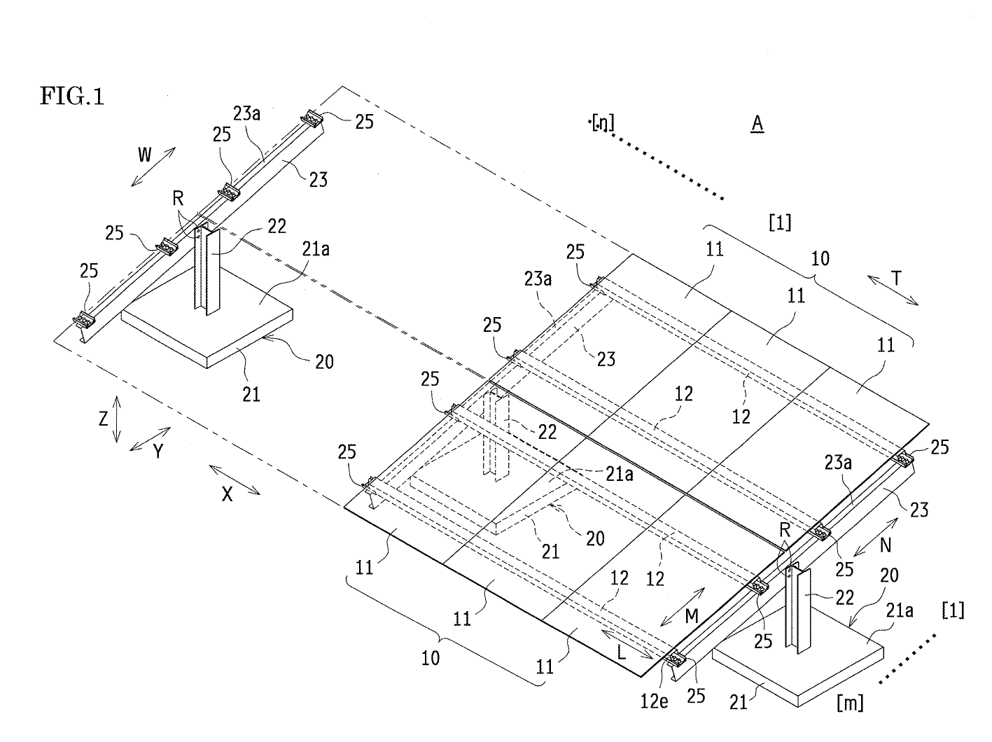

First, the entire structure of a solar power generation system A according to an embodiment of the present invention is described with reference to FIG. 1 to FIG. 3.

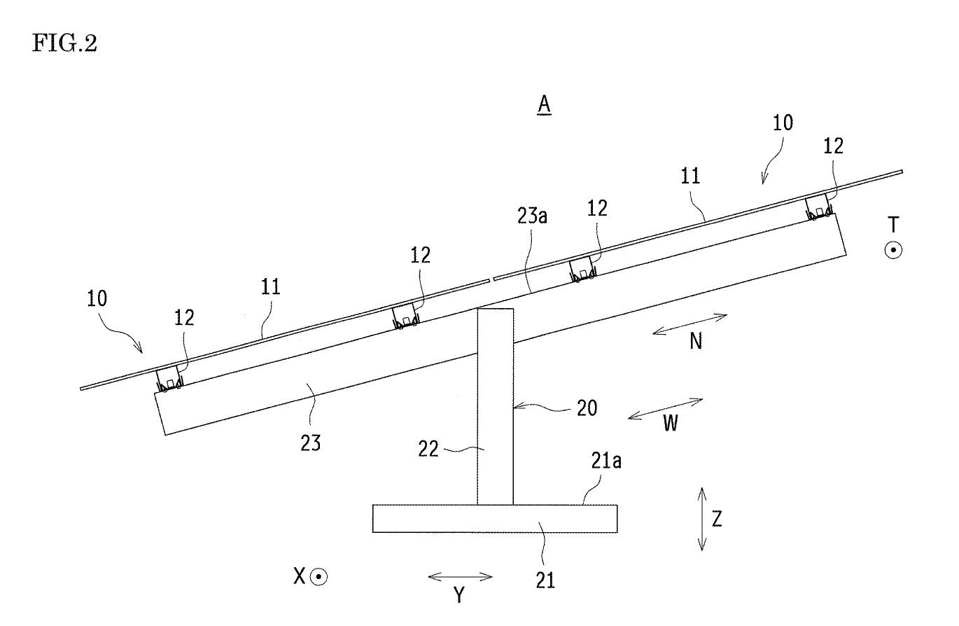

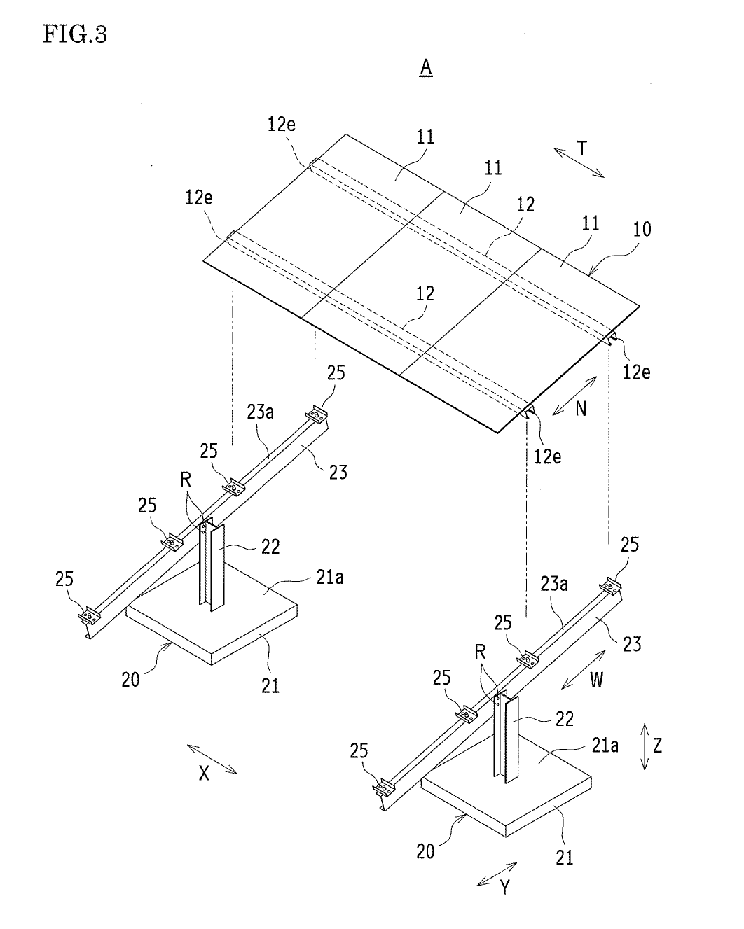

FIG. 1 is a schematic perspective view depicting the entire structure of the solar cell system A in the state in which a sub-unit 10 having a solar cell module body 11 integrally assembled thereto is disposed on a mounting 20, according to the embodiment of the present invention. FIG. 2 is a schematic left side view of the solar power generation system A depicted in FIG. 1. FIG. 3 is a schematic exploded perspective view depicting the state before the sub-unit 10 is installed on the mounting 20.

In the following description, it is assumed that, with respect to the front (a front surface side of the solar cell module), a direction in which bases 21 are arranged is a lateral direction X, a direction orthogonal to both of the lateral direction X and a vertical direction (an up-down direction) Z is a front-back direction Y, and a tilt direction of a longitudinal bar 23 is an up-down tilt direction W. It is also assumed that a longer direction of the solar cell module body 11 is a longitudinal direction N, and a shorter direction of the solar cell module body 11 is a transverse direction T.

The solar power generation system A depicted in FIG. 1 has a structure usable as a solar power station, for example.

The solar power generation system A includes the sub-unit 10 including solar cell module bodies 11 and support rails 12 (an example of a support member) and acting as a solar cell module, and mountings 20 which each support the sub-unit 10.

The sub-unit 10 is provided to the mounting 20 in a matrix of m rows×n columns, with m rows (m is an integer equal to 1 or 2 or more; here m=2) in the up-down tilt direction W and n columns (n is an integer equal to 1 or 2 or more) in the lateral direction X (refer to FIG. 1). The plurality of (here, n+1) mountings 20 are provided in the lateral direction X. Here, when the mounting 20 is present at an intermediate position other than the mountings 20, 20 at both ends in the lateral direction X, the mounting 20 at the intermediate position is taken as a mounting common to the sub-units 10, 10 that are adjacent to each other in the lateral direction X.

The mountings 20 to 20 each configure a support structure for the sub-unit 10, and each includes a base 21 made of concrete or the like, an arm member 22, and a longitudinal bar 23. The arm member 22 and the longitudinal bar 23 are both formed of a steel material such as a steel plate.

In the solar power generation system A, a plurality of (here, n+1) bases 21 to 21 are equidistantly constructed in the lateral direction X on the ground, and each base 21 has the arm member 22 fixed thereto.

In more detailed description, each base 21 stands in the vertical direction Z, with a lower end of the arm member 22 buried at a center part of an upper surface 21a in the front-back direction Y. The arm member 22 supports the longitudinal bar 23 at an upper end with a center part in the front-back direction Y coupled to the longitudinal bar 23 with a coupling member R such as a bolt and nut (refer to FIG. 1 and FIG. 3). The longitudinal bar 23 is provided to the arm member 22 as being tilted at a predetermined angle set in advance so that a back side is high and a front side is low in the front-back direction Y.

The support rails 12 in the sub-unit 10 are installed on the longitudinal bars 23, 23 along the lateral direction X across the longitudinal bars 23, 23 provided to the respective arm members 22, 22 in the bases 21, 21 adjacent to each other in the lateral direction X. The longitudinal bars 23, 23 support the sub-unit 10 of m rows (here, m=2) in the up-down tilt direction W (refer to FIG. 1).

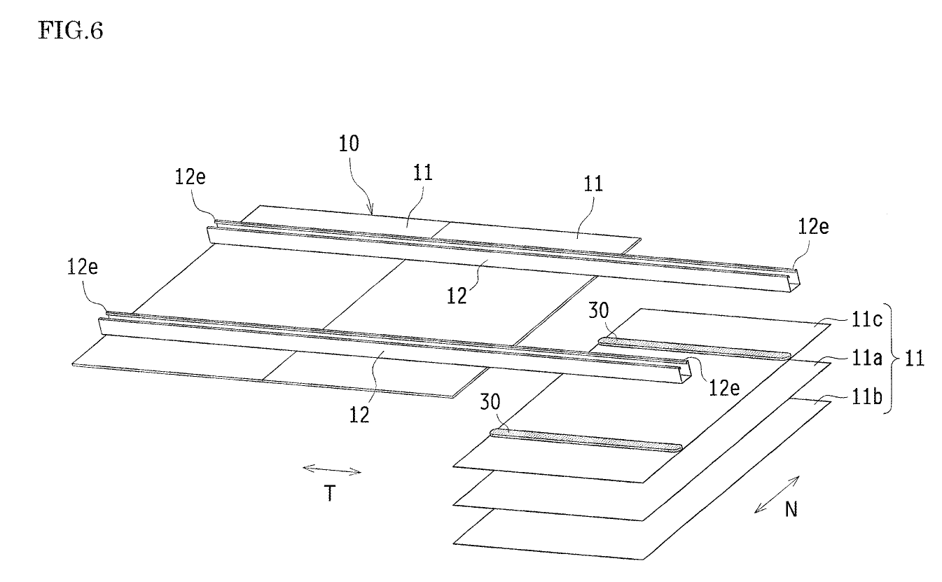

Specifically, in a lower row, the structure is such that installation ends 12e, 12e on both sides of each of a plurality of (here, two) support rails 12, 12 bonded and fixed to the back surface of the solar cell module bodies 11 to 11 via an adhesive 30 (refer to FIG. 6, which will be described further below), which is an example of an adhesive member, fit in receiving parts 25 to 25 mounted at a plurality of locations (here, two locations) on a front side of mount tilted surfaces 23a, 23a of the longitudinal bars 23, 23. In an upper row, the structure is such that, as with the lower row, the installation ends 12e, 12e on both sides of each of a plurality of (here, two) support rails 12, 12 bonded and fixed to the back surface of the solar cell module bodies 11 to 11 via the adhesive 30 (refer to FIG. 6, which will be described further below) fit in receiving parts 25 to 25 mounted at a plurality of locations (here, two locations) on a back side of mount tilted surfaces 23a, 23a of the longitudinal bars 23, 23.

And, the installation ends 12e, 12e of the support rails 12, 12 of each of the sub-units 10, 10 that are adjacent to each other in the lateral direction X abut on each other in the receiving part 25, and fixed with a fixture 24 (an example of a fixing part, and refer to FIG. 27 and FIG. 28, which will be described further below) configuring a support structure for the sub-unit 10. This support structure will be described in detail below.

<Description of Solar Cell Module>

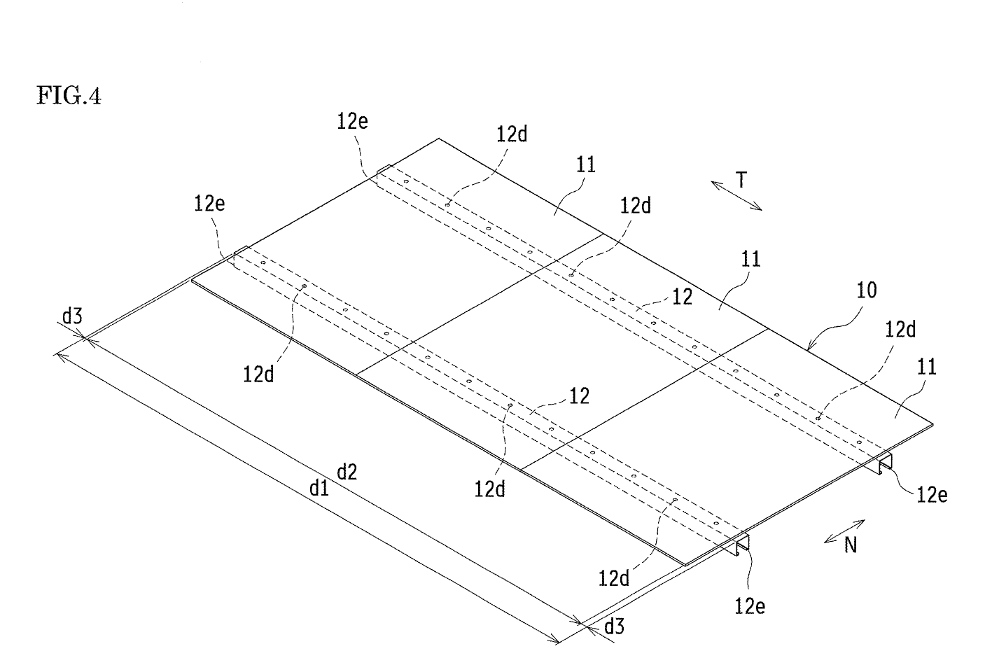

Next, the entire structure of the sub-unit 10 according to the present embodiment is described below with reference to FIG. 4 to FIG. 8.

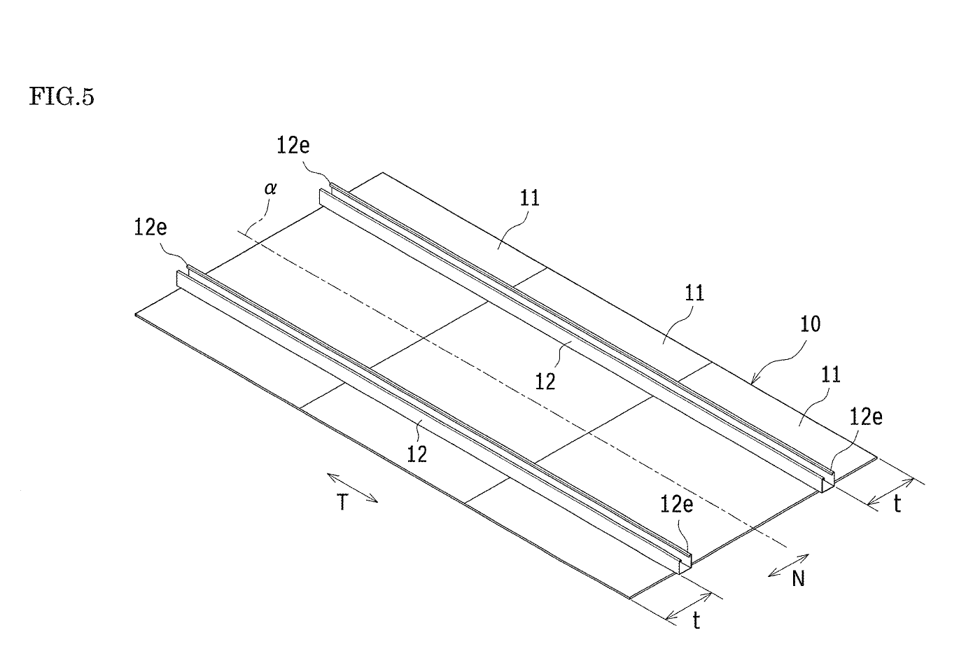

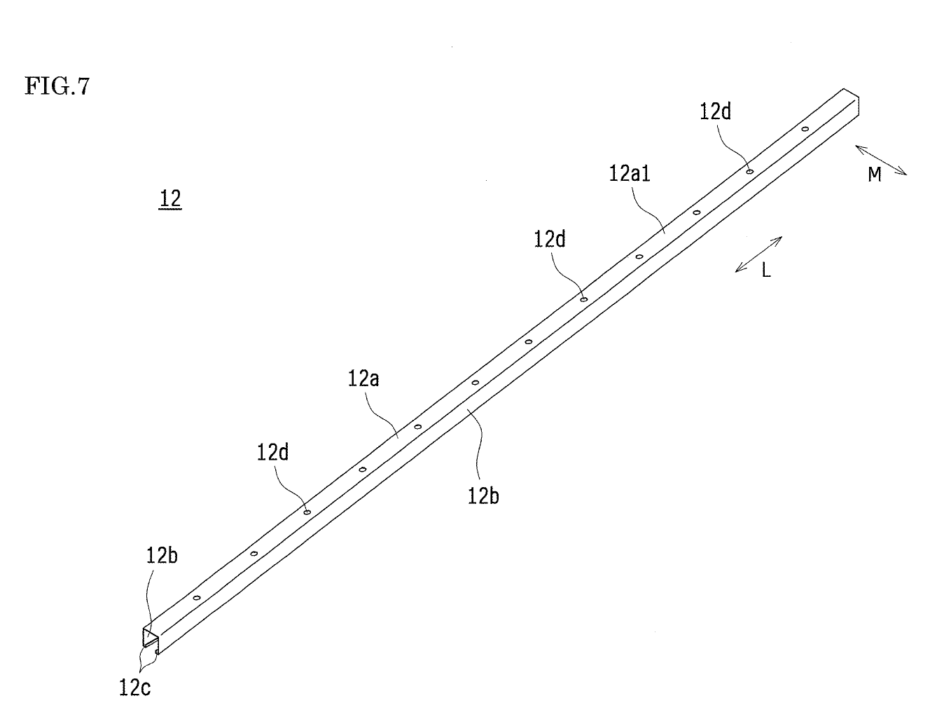

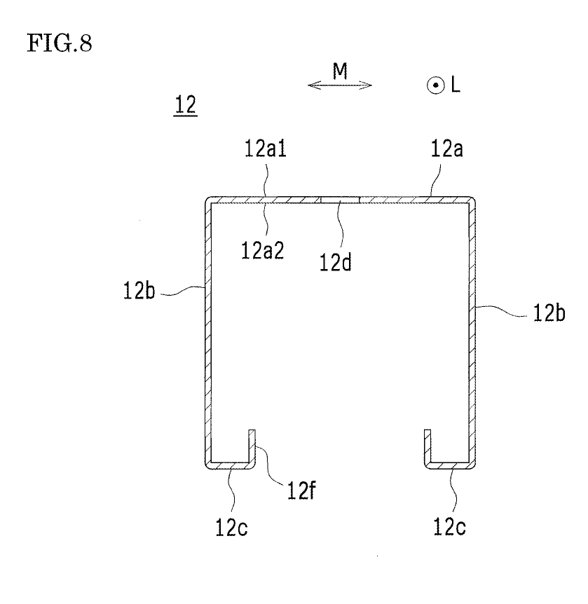

FIG. 4 to FIG. 8 depict a schematic structure of the sub-unit 10 according to the present embodiment. FIG. 4 is a schematic perspective view of the sub-unit 10 viewed from a light-receiving-surface side, and FIG. 5 is a schematic perspective view of the sub-unit 10 viewed from a back surface side opposite to the light-receiving surface. Also, FIG. 6 is a schematic perspective view depicting one solar cell module body 11 as exploded, with the sub-unit 10 viewed from the back surface side. Furthermore, FIG. 7 is a schematic perspective view of the support rail 12 depicted in FIG. 1 to FIG. 6, and FIG. 8 is a schematic sectional view of the support rail 12 depicted in FIG. 1 to FIG. 6. Note in FIG. 7 and FIG. 8 that a direction in which the support rail 12 extends is assumed to be a longer direction L and a direction orthogonal thereto is assumed to be a shorter direction M.

The sub-unit 10 is configured of one or plurality of (here, contiguously-installed three in the lateral direction X) solar cell module bodies 11 to 11 and one or plurality of (here, two installed in the longer direction N in parallel with the shorter direction T) support rails 12, 12.

The solar cell module body 11 is shaped in a rectangular flat plate, and has a structure in the present embodiment as depicted in FIG. 6 in which a solar cell group 11a is interposed between a light-receiving-surface glass 11b and a back surface glass 11c and the ends of both of the glasses 11b and 11c are sealed. That is, in the present embodiment, the solar cell module body 11 is a thin-film solar cell module in a laminated glass structure and has a frameless structure. However, the solar cell module body 11 is not restricted to have a laminated glass structure, and may be of a back-surface back-sheet type using a film-shaped back sheet in place of the back surface glass 11c.

As depicted in FIG. 7 and FIG. 8, the support rail 12 has a long main plate 12a, side plates 12b, 12b obtained by folding both sides on a long side of the main plate 12a in the shorter direction M, and folded reinforcing parts 12c, 12c obtained by folding lower sides of the respective side plates 12b and 12b inwardly and then further upwardly. That is, the support rail 12 has a sectional shape in a substantially lip channel steel (a U-shaped sectional shape). Also, in the support rail 12, an upper surface 12a1 of the main plate 12a is an adhesive surface to be coated with an adhesive, and both lower ends of each of the side plates 12b, 12b and both ends of each of the folded reinforcing parts 12c, 12c serve as the installation ends 12e, 12e. The support rail 12 with the structure as described above can be formed by stamping and folding a steel plate and then plating its surface.

In the sub-unit 10 according to the present embodiment, the above-structured support rail 12 is arranged and fixed to the back surface of the solar cell module body 11 (here, an outer front surface of the back surface glass 11c) along the transverse direction T of the solar cell module body 11.

In more detailed description, the sub-unit 10 has the plurality of (here, three) solar cell module bodies 11 to 11 disposed so as to be aligned in the transverse direction T and the plurality of (here, two) support rails 12, 12 disposed so as to be orthogonal to a direction of a boundary between the solar cell module bodies 11, 11, that are adjacent in the transverse direction T and be parallel with each other with a constant space in the longitudinal direction N. Also, in the sub-unit 10, the back surface of each of the solar cell module bodies 11 to 11 (here, the outer front surface of the back surface glass 11c) and a surface of each of the support rails 12, 12 on a solar cell module body 11 side are superposed each other to be bonded via the adhesive 30 (refer to FIG. 6), and the solar cell module bodies 11 to 11 are coupled and supported by the support rails 12, 12. Here, in view of avoiding damage due to a mutual contact, a slight gap (for example, on the order of 1 cm) may be provided between the solar cell module bodies 11, 11 that are adjacent to each other in the transverse direction T, or the solar cell module bodies 11 to 11 that are adjacent to each other in the transverse direction T may be in contact with each other. Also, as the adhesive 30, 2-liquid silicone adhesive can be used.

As such, with the plurality of (here, two) support rails 12 arranged in parallel with each other along the transverse direction T of the solar cell module bodies 11, the sub-unit 10 can be stably mounted and fixed onto the mounting 20 without backlash in the longitudinal direction N when the sub-unit 10 is mounted on the mounting 20.

Disposed along the transverse direction T in parallel with each other with a constant space in the longitudinal direction N of the solar cell module bodies 11, the support rails 12 are provided at a position symmetrical or substantially symmetrical to a center line α (refer to FIG. 5) passing through the center of the longitudinal direction N and parallel with the transverse direction T on the back surface of the solar cell module bodies 11 in the present embodiment. In more detailed description, the positions of the support rails 12 are those inwardly in the longitudinal direction N away from both end edges of the solar cell module bodies 11 in the longitudinal direction N by a predetermined distance t set in advance (refer to FIG. 5).

As such, with the support rails 12, 12 disposed at the positions inwardly in the longitudinal direction N away from both end edges of the solar cell module bodies 11 in the longitudinal direction N by the distance t, the weight of the solar cell module bodies 11 over the support rails 12, 12 can be distributed in balance. With this, weight distribution to the support rails 12, 12 can be made uniform.

As examples of specific numerical values, the solar cell module body 11 is in a rectangular shape in a planar view, with a length in the longitudinal direction N of approximately 1400 mm and a length in the transverse direction T of approximately 1000 mm. The support rails 12, 12 are arranged at positions inwardly in the longitudinal direction N away from both end edges of the solar cell module bodies 11 in the longitudinal direction N by the distance t of approximately 300 mm. However, the present invention is not restricted by these numerical values.

Note that the position where each support rail 12 is disposed is preferably a center position between each of the both end edges in the longitudinal direction N of the solar cell module bodies 11 and the center line α. With this, the weight of the solar cell module bodies 11 over the support rails 12, 12 can be distributed further in balance. With this, weight distribution to the support rails 12, 12 can be made more uniform.

Also, as depicted in FIG. 4, each of the support rails 12, 12 has a length d1 in the transverse direction X in the sub-unit 10 slightly longer than a length d2 in the transverse direction T of each of the entire solar cell module bodies 11 to 11 in the sub-unit 10. Each of the support rails 12, 12 is bonded over a substantially entire region of the bonding part of each of the solar cell module bodies 11 to 11 in the sub-unit 10 to increase an area of bonding with each of the solar cell module bodies 11 to 11 as much as possible. And, projection amounts d3 at both ends of each of the support rails 12, 12 in the transverse direction T projecting from both end positions of the entire solar cell module bodies 11 to 11 in the transverse direction T in the sub-unit 10 are matched with each other.

Note that the length d1 of each of the support rails 12, 12 in the transverse direction T in the sub-unit 10 may be equal to or substantially equal to the length d2 of the entire solar cell module bodies 11 to 11 in the transverse direction T in the sub-unit 10. In this case, both end positions in each of the support rails 12, 12 and both end positions of the entire solar cell module bodies 11 to 11 in the transverse direction T in the sub-unit 10 can be matched with each other. Here, in view of avoiding damage due to a mutual contact, a slight gap (for example, on the order of 1 cm) may be provided between the sub-units 10, 10 that are adjacent to each other in the transverse direction T (between the solar cell module bodies 11 at left end or right end in the transverse direction T), or the sub-units 10, 10 that are adjacent to each other in the transverse direction T (solar cell module bodies 11 at the left end or right end in the transverse direction T) may be in contact with each other. Also, as with the case of the transverse direction T, in view of avoiding damage due to a mutual contact, a slight gap (for example, on the order of 1 cm) may be provided between the sub-units 10, 10 that are adjacent to each other in the longitudinal direction N (the solar cell module bodies 11 at an upper end or a lower end in the longitudinal direction N), or the sub-units 10, 10 that are adjacent to each other in the longitudinal direction N (the solar cell module bodies 11 at the upper end or the lower end in the longitudinal direction N) may be in contact with each other.

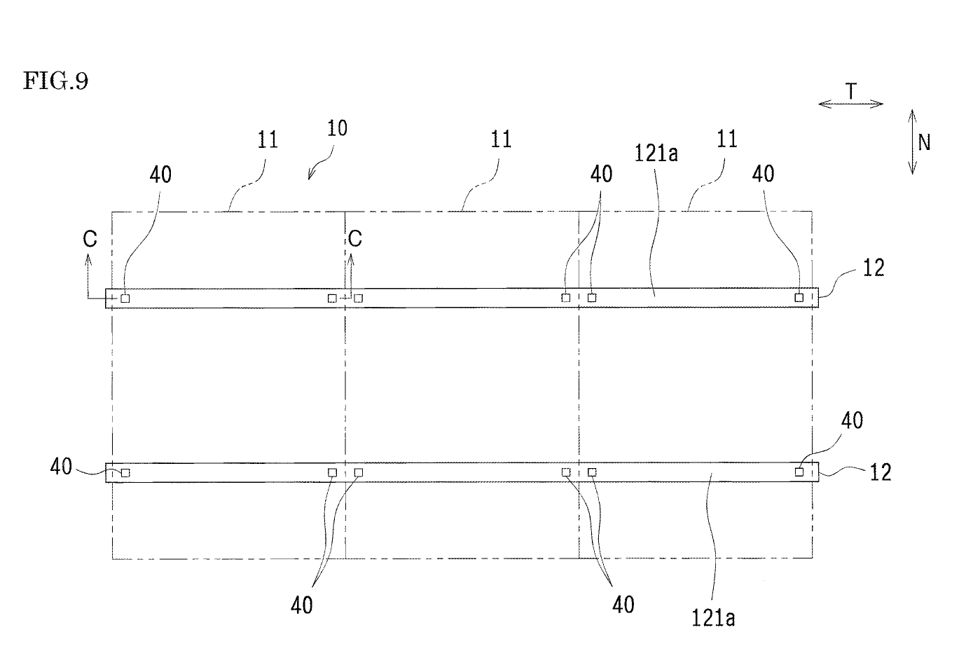

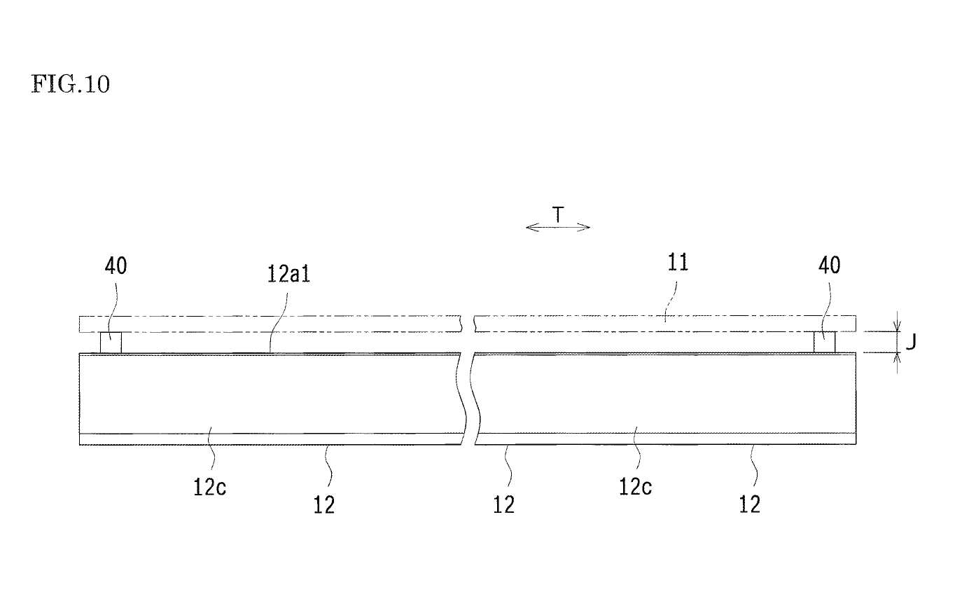

FIG. 9 is a plan view depicting the state in which two support rails 12 are arranged in parallel with each other with a predetermined space, and FIG. 10 is a schematic sectional view along a C-C line of FIG. 9. However, in FIG. 9 and FIG. 10, the solar cell module bodies 11 to be mounted on the two support rails 12 are depicted with two-dot-chain lines.

As depicted in FIG. 10, the present embodiment adopts a structure in which spacer members 40 for ensuring the thickness of the adhesive 30 for coating are arranged between the back surface of each solar cell module body 11 and the adhesive surface 12a1 of the support rail 12. With the spacer members 40 arranged between the back surface of the solar cell module body 11 and the adhesive surface 12a1 of the support rail 12, the thickness of the adhesive 30 for coating on the adhesive surface 12a1 can be ensured. Therefore, adhesive strength between the support rail 12 and the solar cell module body 11 can be increased, and a favorable bonding state can be kept.

In more specific description, the spacer members 40 are configured to be arranged at plurality of locations of the support rail 12 in a longer direction (in FIG. 9, the transverse direction T) for one solar cell module body 11. In the example depicted in FIG. 9, the spacer members 40 are arranged at both ends of the solar cell module body 11. According to this structure, with the spacer members 40 arranged at a plurality of locations for one solar cell module body 11 (that is, two or more spacer members 40 are arranged), a gap J (refer to FIG. 10) between the support rail 12 and the back surface of the solar cell module body 11 can be kept at a predetermined width over the full length in the transverse direction T.

However, the spacer members 40 may be arranged not only at both ends of the solar cell module body 11, but also further at one or plurality of locations along a longer direction (in FIG. 9, the transverse direction T) between both ends.

According to this structure, by arranging the spacer member 40 at a location other than both ends, the thickness of the adhesive 30 can be kept approximately uniform over the full length of the support rail 12. Therefore, adhesive strength can also be kept approximately uniform over the full length of the support rail 12.

Here, as the thickness of the spacer member 40, for example, 3 mm or so is suitable, but this thickness is not meant to be restrictive. Also, as a material for a base material of the spacer member 40, a resin material such as polyurethane foam, acrylic foam, or urethane can be used. Furthermore, as an adhesive member for bonding this base material to adhesive regions of the adhesive surface 12a1 of the support rail 12 and the back surface of the solar cell module body 11, an acrylic adhesive or an urethane adhesive can be used, as well as a butyl tape. Still further, the spacer members 40 themselves can be configured of a double-sided adhesive tape. By using a double-sided adhesive tape as the spacer members 40, the operation of arranging the spacer members can be facilitated.

<Description of Method of Producing Sub-Unit 10>

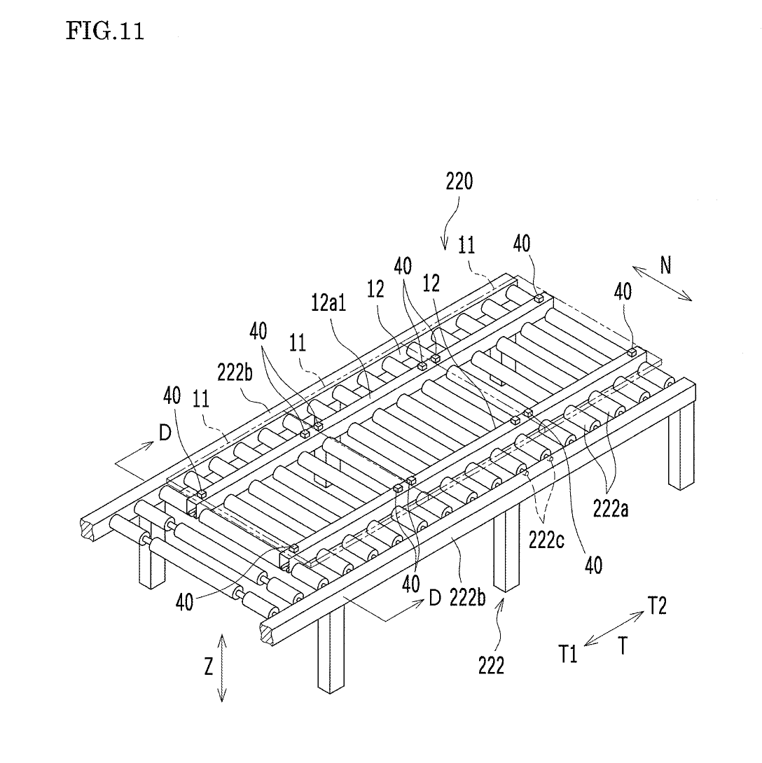

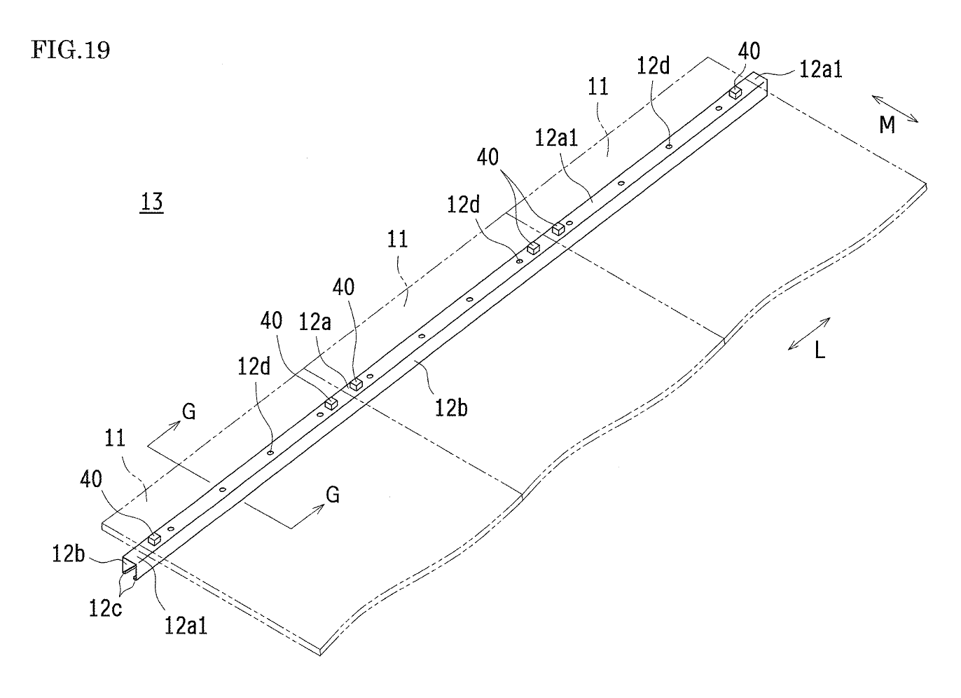

Next, a method of producing the sub-unit 10, in particular, a bonding process of bonding the solar cell module body 11 and the support rails 12 via the adhesive 30, is described with reference to each of the drawings for describing processes depicted in FIG. 11 to FIG. 15 (FIG. 19 to FIG. 23).

The method of producing the sub-unit 10 according to the present invention is configured to include an arranging process of arranging the plurality of support rails 12 in parallel with each other with a predetermined space, a process of arranging the spacer member 40 for ensuring the thickness of the adhesive 30 in either one of an adhesive region of the solar cell module body 11 on the back surface side where the support rails 12 are bonded and an adhesive region of the adhesive surface 12a1 of each support rail 12 (in this example, the adhesive region of the adhesive surface 12a1 of each support rail 12), a coating process of coating either one of the adhesive region of the solar cell module body 11 on the back surface side where the support rails 12 are bonded and the adhesive region of the adhesive surface 12a1 of each support rail 12 (in this example, the adhesive region of the adhesive surface 12a1 of each support rail 12) with the adhesive 30, and a laminating process of laminating the adhesive region of the solar cell module body 11 on the back surface side onto the adhesive surface 12a1 of each support rail 12 to bond the support rails 12 and the solar cell module body 11 together. According to this production method, by arranging the spacer members 40, the thickness of the adhesive 30 can be kept at the constant thickness J defined by the spacer members 40. Therefore, adhesive strength can be increased over the full length in one direction.

Each process is described in detail below.

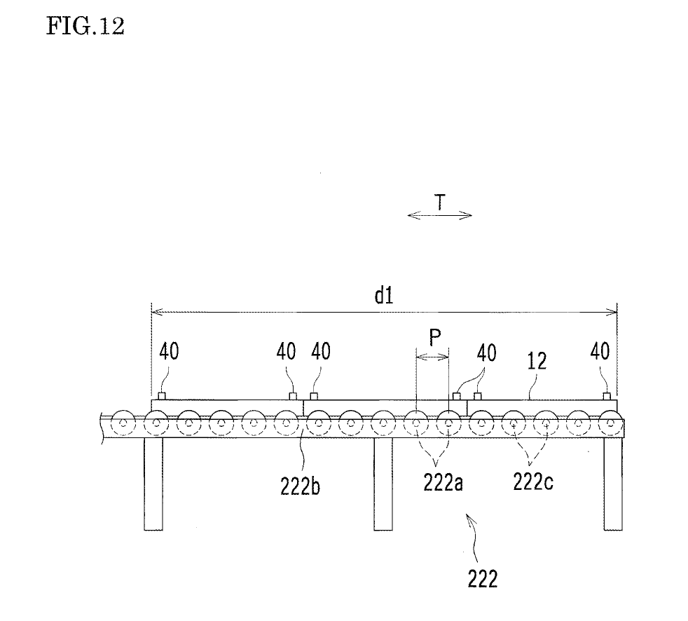

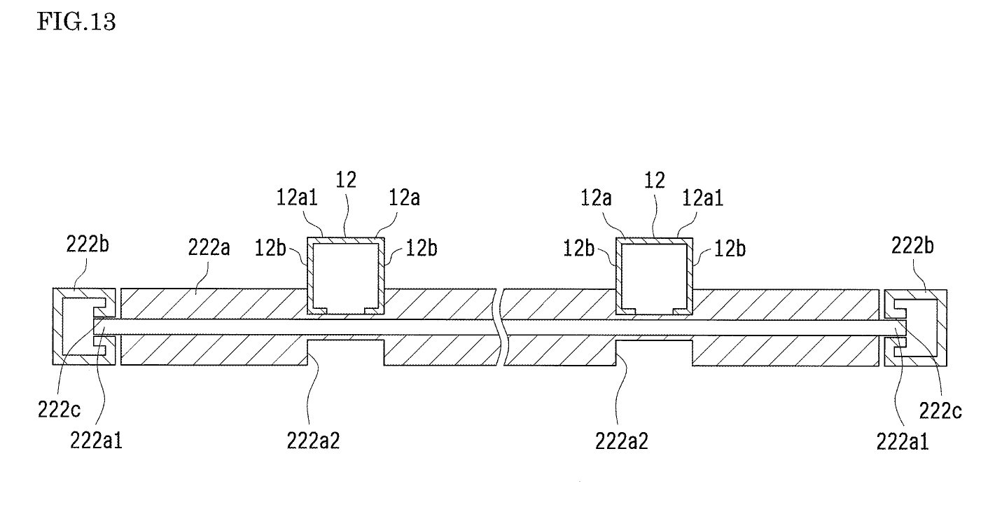

In the process of arranging the support rails 12, a mounting device 220 depicted in FIG. 11 to FIG. 13 is used. FIG. 11 is a schematic perspective view depicting an example of the mounting device, FIG. 12 is a schematic side view of the mounting device, and FIG. 13 is a schematic sectional view along a G-G line of FIG. 11. However, in FIG. 11, the solar cell module bodies 11 to be mounted in the subsequent process are depicted with two-dot-chain lines.

The mounting device 220 is to mount and support two support rails 12 with a certain space, and includes a mount roller part 222 also for delivery.

The mount roller part 222 is configured to mount and support the support rails 12 so that the adhesive surface 12a1 is oriented upward, with the support rails 12 positioned so as to be laminated onto the solar cell module bodies 11.

Specifically, the mount roller part 222 has a length longer than the length d1 of the support rail 12 (refer to FIG. 12), and can deliver the sub-unit 10 having the support rails 12 and the solar cell module bodies 11 laminated together via the adhesives 30 to the next maturing process. Note that the maturing process is a process of curing the adhesive 30 so that adhesive power of the adhesive 30 is sufficiently obtained.

The mount roller part 222 includes a plurality of mount rollers 222a to 222a provided in parallel with each other along the transverse direction T so as to be parallel with each other in the longitudinal direction N and paired support frames 222b, 222b which rotatably support both ends of the mount rollers 222a to 222a in the longitudinal direction N.

The mount rollers 222a to 222a each have a length approximately equal to the length of the solar cell module body 11 in the longitudinal direction N. Also, the mount rollers 222a to 222a are arranged at a pitch P so as not to make contact with each other (refer to FIG. 12). Here, in the mount rollers 222a to 222a, each pitch P is half of or shorter than the width of the solar cell module body 11 in the transverse direction T, and the support rail 12 is supported by at least three or more (here, five) mount rollers 222a to 222a for one solar cell module body 11.

The paired support frames 222b, 222b are long members disposed in parallel with each other on both sides in the longitudinal direction N across the mount rollers 222a to 222a and elongated in the transverse direction T, and each have a plurality of bearings 222c to 222c provided in a line along the transverse direction T on an inner side surface facing the mount rollers 222a to 222a. With rotating shafts 222a1, 222a1 at both ends supported by the bearings 222c to 222c of the paired support frames 222b, 222b, the mount rollers 222a to 222a are rotatably supported by the paired support frames 222b, 222b.

In the above-structured mount roller part 222, as depicted mainly in FIG. 13, paired fitting groove parts 222a2, 222a2 are formed over the entire perimeter of an outer circumferential surface of each of the mount rollers 222a to 222a at a constant space in the longitudinal direction N. This fitting groove part 222a2 is formed to have a width into which both side plates 12b, 12b of the support rail 12 are interposed. With the support rail 12 fitting in each of the fitting groove parts 222a2 to 222a2 aligned in a line in the transverse direction T of each of the mount rollers 222a to 222a, the bonding position with respect to the solar cell module body 11 can be determined.

In the process of arranging the support rails 12, as depicted in FIG. 11 and FIG. 12, two support rails 12, 12 are supported and mounted as each fitting in a row of the fitting groove parts 221a2, with the adhesive surface 12a1 facing upward.

In the process of arranging the spacer members 40, as depicted in FIG. 11, the spacer members 40 are arranged at a plurality of locations (in this example, both ends of the solar cell module body 11) on the adhesive surface 12a1 of each support rail 12 in a longer direction (in FIG. 11, the transverse direction T) of the support rail 12 for one solar cell module body 11. That is, in this example, six spacer members 40 are arranged (that is, bonded and fixed) on one support rail 12 along the transverse direction T.

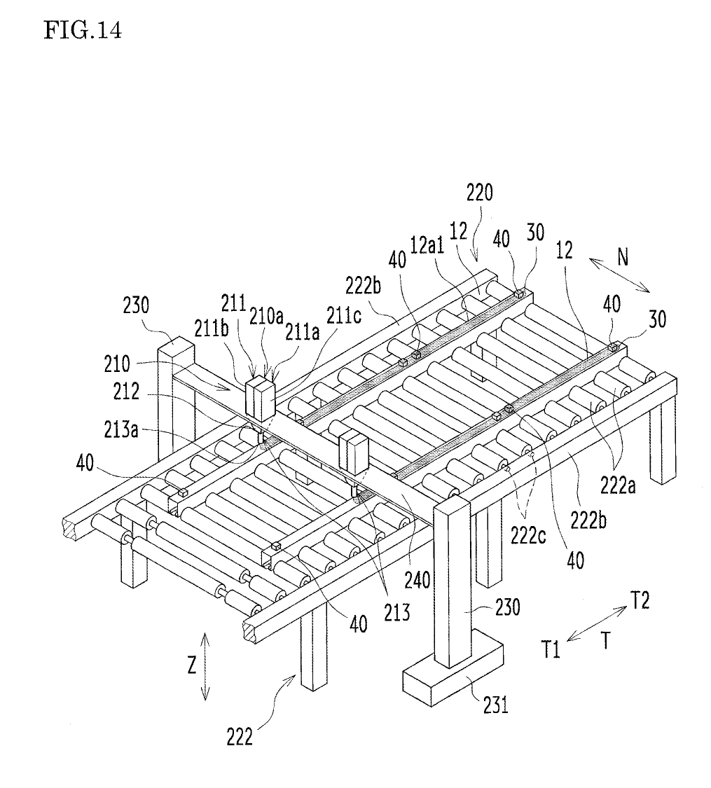

In the coating process, a coating device 210 depicted in FIG. 14 is used. FIG. 14 is a schematic perspective view depicting an example of the coating device provided to the mounting device.

The coating device 210 coats the adhesive surface 12a1 of the support rail 12 with the adhesive 30. In the present embodiment, coating with the adhesive 30 is performed by moving nozzles 213a, which will be described further below, relatively to the support rail 12 mounted and supported on the mounting device 220.

Specifically, the coating device 210 includes a coating part 210a for coating with the adhesive 30. The coating part 210a includes an adhesive accommodating part 211, an adhesive supply part 212, and an adhesive discharge part 213.

The adhesive accommodating part 211 has an accommodation tank 211a for accommodating the adhesive 30. In this example, 2-liquid silicone adhesive is used as the adhesive 30. The accommodation tank 211a has a first tank 211b for accommodating a first adhesive material and a second tank 211c for accommodating a second adhesive material.

The adhesive supply part 212 supplies the adhesive 30 accommodated in the adhesive accommodating part 211 to the adhesive discharge part 213. In this example, the adhesive supply part 212 supplies the first adhesive material from the first tank 211b to the adhesive discharge part 213 and second adhesive material from the second tank 211c to the adhesive discharge part 213, thereby causing these adhesive materials to be mixed at the adhesive discharge part 213.

The adhesive discharge part 213 has the nozzle 213a for discharging the adhesive 30. Regarding the number of nozzles 213a, one nozzle is provided to one support rail 12 in this example.

In the above structure, the coating part 210a has the adhesive accommodating part 211, the adhesive supply part 212, and the adhesive discharge part 213 integrally formed therein, and is supported by a holding member 240 provided to bridge the support members 230, 230, as many as the number of support rails 12 (in this example, two). The support members 230, 230 is disposed on both sides across the support frames 222b, 222b of the mounting device 220 in the longitudinal direction N, and the holding member 240 is supported along the longitudinal direction N as bridging over the support members 230, 230.

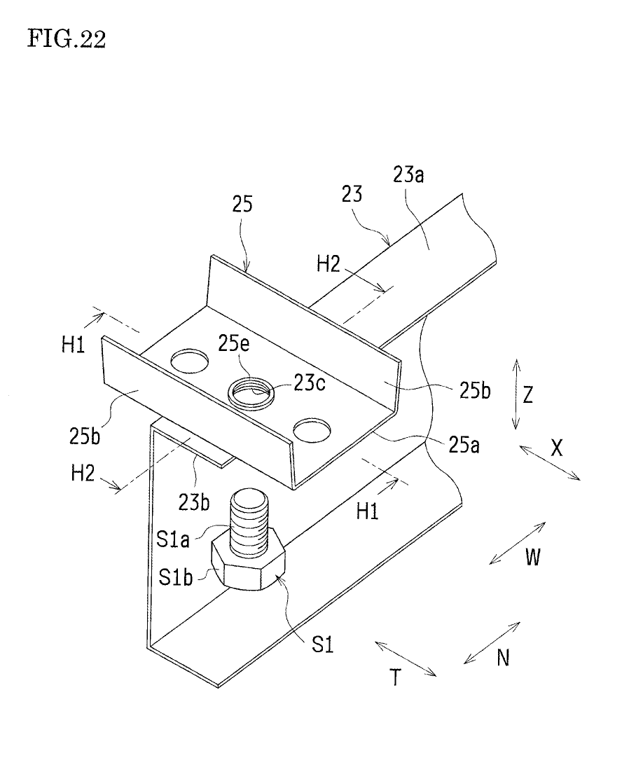

Also, the support frames 230, 230 are fixed onto mobile carriages 231, 231 (however, only one at the front is depicted in FIG. 22). With these mobile carriages 230, 230, the entire coating device 210 can make a reciprocating movement in the transverse direction T.

In the coating process, while the coating device 210 is moved at a constant speed in one direction T1 of the transverse direction T, a constant discharge amount of the adhesive 30 is discharged from each of the nozzles 213a, 213a, and the adhesive surface 12a1 of each support rail 12 is coated with the adhesive 30 over an approximately full length of the support rail 12. In this case, discharge of the adhesive 30 is stopped at the position of each spacer member 40. That is, while the adhesive 30 is intermittently discharged so that the position of each spacer member 40 is excluded, coating with the adhesive 30 is sequentially performed over an approximately full length of the support rail 12.

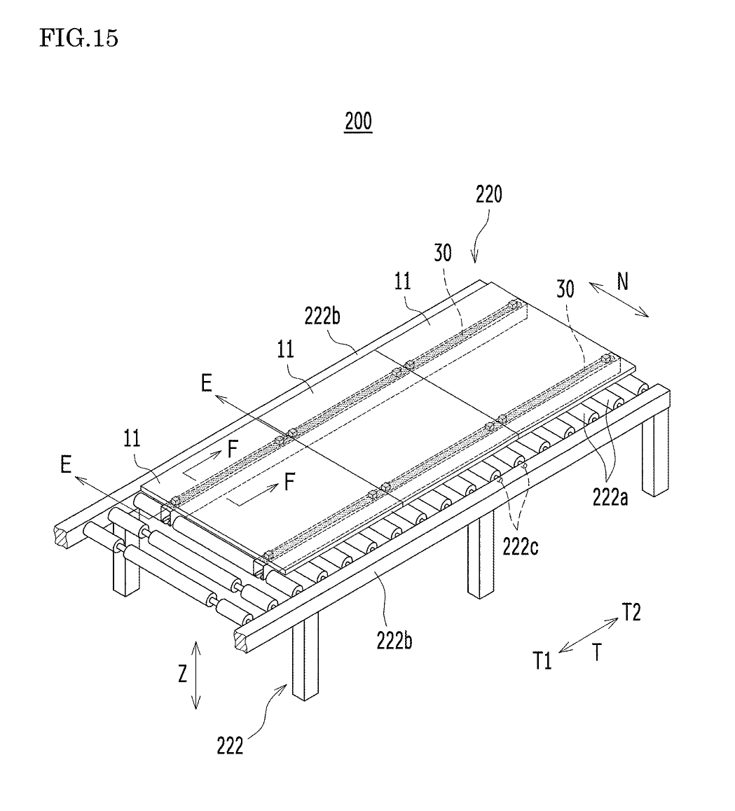

In the laminating process, as depicted in FIG. 15, three solar cell module bodies 11 with their back surface side facing downward are sequentially and horizontally mounted on the support rails 12 coated with the adhesive 30 and supported by the mounting device 220. In this case, the solar cell module bodies 11 have to be positioned with respect to the support rails 12. Regarding a positioning method in this case, any of various conventionally-known methods can be adopted, and a known method can be adopted also in the present embodiment. For example, a positioning pin (or a positioning plate) for positioning in the transverse direction T and a positioning pin (or a positioning plate) for positioning in the longitudinal direction N are provided near the mount rollers 222a to 222a, and the first solar cell module body 11 (in FIG. 15, for example, the solar cell module body 11 on a left front side) is mounted so that two sides of the solar cell module body 11 abut on the positioning pins. With this, the solar cell module body 11 can be mounted at a predetermined position with respect to the support rails 12 (the support rails 12, 12 can be at the positions inwardly in the longitudinal direction N away from both end edges of the solar cell module bodies 11 in the longitudinal direction N by approximately 300 mm, as described above). The second and third solar cell module bodies 11 are sequentially mounted with reference to the first solar cell module body 11.

In this case, in the present embodiment, the solar cell module bodies 11 are mounted on the support rails 12, 12 (that is, bonding is performed in an actual use state). Therefore, even if any of the solar cell module bodies 11 is warped or the like, that warping is corrected by self weight (approximately 20 Kg) of the solar cell module body 11. Therefore, if delivery to the next maturing process is made in this state, the back surfaces of the solar cell module bodies 11 and the adhesive surface 12a1 of the support rails 12 are approximately uniformly bonded together over the full length. Also, as described above, since bonding and maturation is performed in an actual use state, a stress different from that at the time of bonding is not exerted onto the bonding portion in an actual use of the solar power generation system at a later time.

While bonding of the spacer members 40 and coating with the adhesive 30 are performed on a support rail 12 side in the present embodiment, bonding of the spacer members 40 and the coating with the adhesive 30 can be performed on the bonding part (adhesive region) on the back surface side of the solar cell module bodies 11 and, in this state, the adhesive region on the back surface side of each solar cell module body 11 can be laminated so as to be positioned at the adhesive surface 12a1 of the support rails 12 mounted and supported on the mounting device 220.

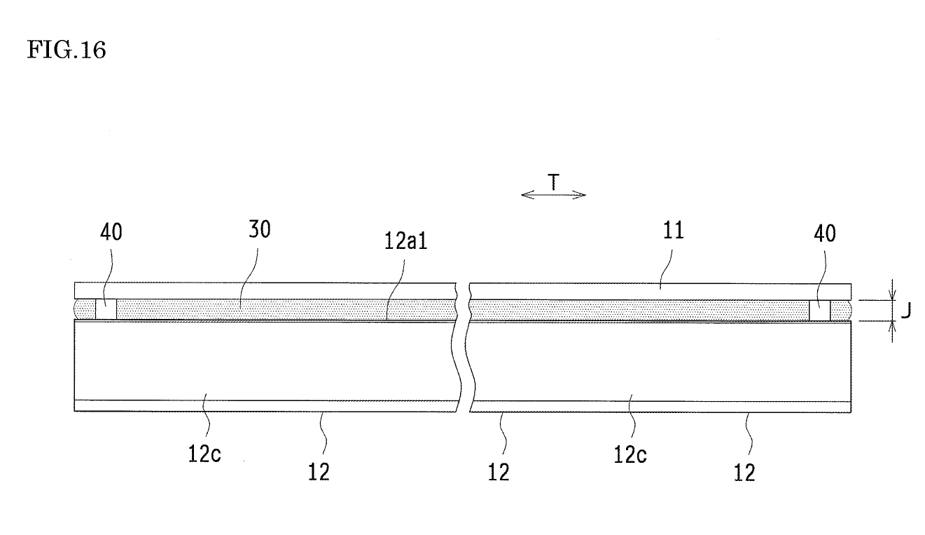

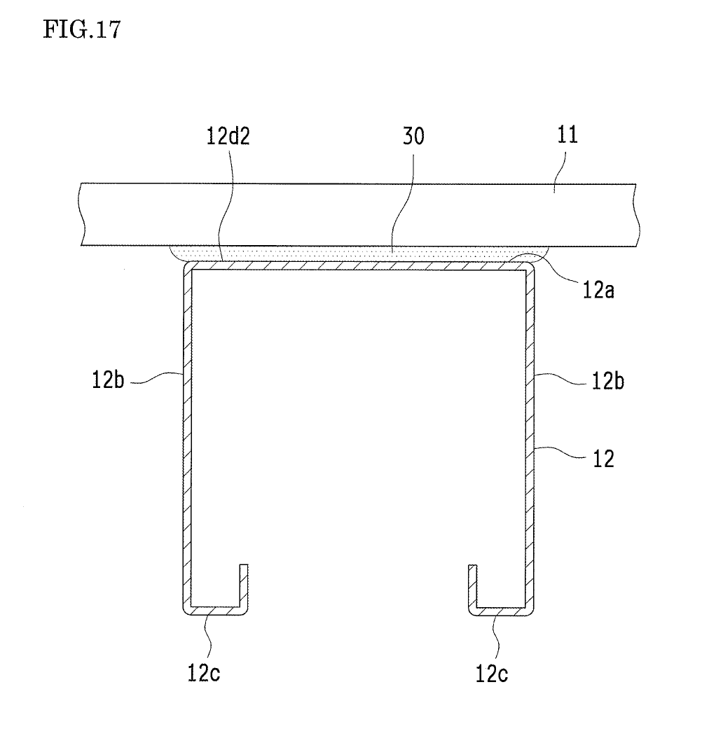

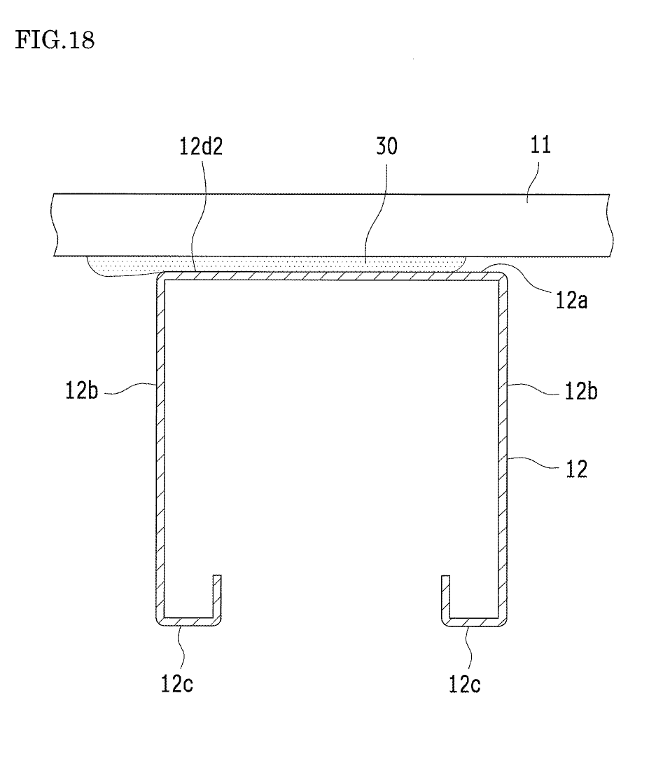

FIG. 16 is a sectional view along an E-E line of FIG. 15, FIG. 17 is a sectional view along an F-F line of FIG. 15, and FIG. 18 is a sectional view along the F-F line of FIG. 15. However, the location to be coated with the adhesive 30 is slightly different between FIG. 17 and FIG. 18.

In the sub-unit 10 produced by the above-described production method, with the spacer members 40 arranged at two locations at both ends for one solar cell module body 11 (that is, two spacer members 40 are arranged), as depicted in FIG. 16, the gap J between the support rail 12 and the back surface of the solar cell module body 11 can be kept at a constant width over the full length in the transverse direction T. Therefore, the thickness of the adhesive 30 for coating can also be ensured to have the constant thickness J.

Also, by coating the entire surface of the adhesive surface 12a1 of each support rail 12 with the adhesive 30 uniformly and with a sufficient thickness (for example, 4 mm, which is thicker than the thickness of the spacer member 40), in the state in which the adhesive 30 is cured after bonding, as depicted in FIG. 17, the adhesive 30 can be provided as running over from both sides in the transverse direction along a longer direction of each support rail 2 (in FIG. 17, the longitudinal direction N).

On the other hand, by coating with a sufficient thickness (for example, 4 mm, which is thicker than the thickness of the spacer member 40) of the adhesive 30 as being put to one side of the adhesive surface 12a1 of the support rail 12 along the longer direction, in the state in which the adhesive 30 is cured after bonding, as depicted in FIG. 18, the adhesive 30 can be provided as running over from only one side along the longer direction of each support rail 2 (in FIG. 17, the longitudinal direction N).

As such, by providing the adhesive 30 running over one side or both sides of the adhesive surface 12a1 of the support rail 12 along the longer direction, when this sub-unit 10 is mounted on the mounting 20 as being tilted, at least the side where the adhesive 30 runs over is arranged on an upper tilted side. With this, water droplets attached and flowing on the back surface of the sub-unit 10 can be prevented from immersing between the back surface of the solar cell module body 1 and the adhesive surface 12a1 of the support rail 12.

<Description of another Example of Structure of Support Rail>

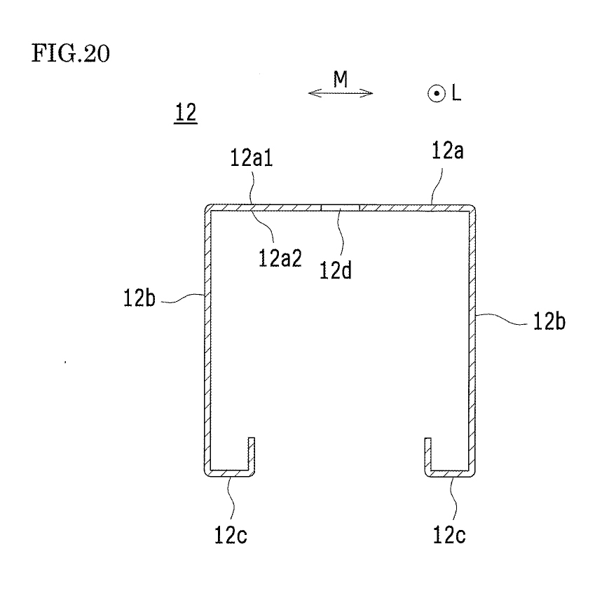

FIG. 19 is a sectional perspective view depicting another example of structure of the support rail, and FIG. 20 is a sectional view along a G-G line of FIG. 19.

In the support rail 12 depicted in FIG. 19, the main plate 12a is provided with holes (hereinafter referred to as check holes) 12d at a plurality of locations with a constant space along the longer direction L. These check holes 12d are provided to penetrate from the adhesive surface 12a1 of the main plate 12a to a surface 12a2 on an opposite side (refer to FIG. 20). Also, the size of each check hole 12d is on the order of several mm to several tens of mm (for example, 5 mm) in diameter. With the check holes 12d provided to the support rail 12, the bonding state can be checked by visual inspection from these check holes 12d after the support rail 12 is bonded to the back surfaces of the solar cell module bodies 11 with the adhesive 30.

In more detailed description, in the present embodiment, these check holes 12d are provided at a plurality of locations (in this example, four locations for one solar cell module body 11 and therefore twelve locations in total) over the full length in the longer direction L. As such, with provision at the plurality of locations over the full length in the longer direction L, whether the bonding state is good or bad can be checked at the plurality of locations in the longer direction L. Therefore, it is possible to easily check whether the adhesive has been favorably bonded over the full length of the support rail 12.

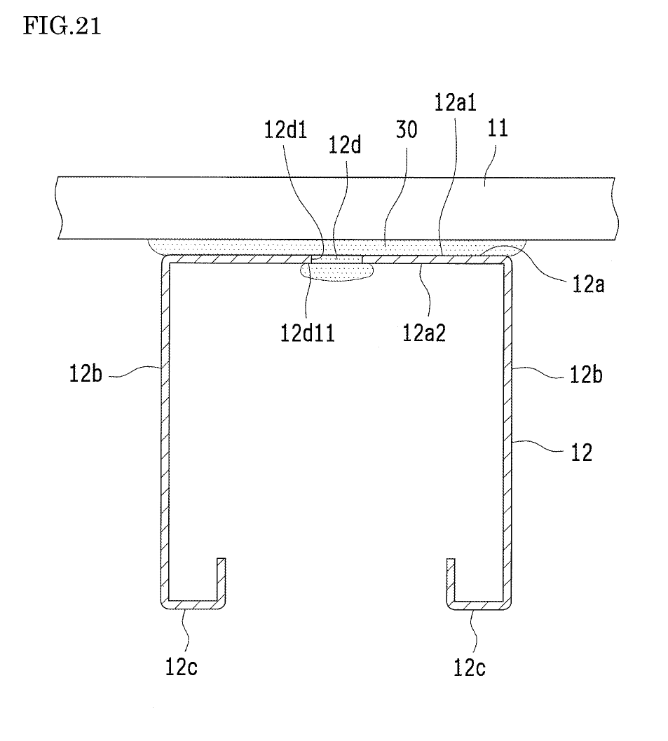

FIG. 21 is a sectional view of the support rail 12 of the other example of structure bonded to the back surface of the solar cell module body 11. As depicted in FIG. 21, the adhesive 30 is provided so as to be immersed into the check hole 12d to cover at least an inner circumferential surface 12d1 of the check hole 12d. In FIG. 21, the adhesive 30 is provides so as to run over from the inner circumferential surface 12d1 further to its circumferential edge part 12d11.

When a plated steel plate is used as the support rail 12, the check holes 12d are formed by hole processing, and rust tends to occur from a hole processed portion. However, by covering at least the inner circumferential surface 12d1 of each check hole 12d with the adhesive 30, the occurrence of rust can be prevented.

<Description of Bonding Structure of Sub-Unit>

Finally, the installation structure for installing the sub-units 10 produced as described above on the mounting 20 is described. That is, the bonding structure in which the sub-units 10, 10 that are adjacent to each other in the lateral direction X are bonded to the longitudinal bars 23 of the mounting 20 is described below with reference to FIG. 22 to FIG. 26.

FIG. 22 is a schematic perspective view of the state in which the receiving part 25 is mounted on and fixed to the longitudinal bar 23, when viewed from diagonally above. Note that while a plurality of (here, four) receiving parts 25 are provided to one longitudinal bar 23, mounting structures of the longitudinal bar 23 and the receiving parts 25 are all substantially similar, and therefore a mounting structure with the longitudinal bar 23 and the receiving part 25 at one location is representatively depicted in FIG. 22 and FIG. 23 to FIG. 26, which will be described further below.

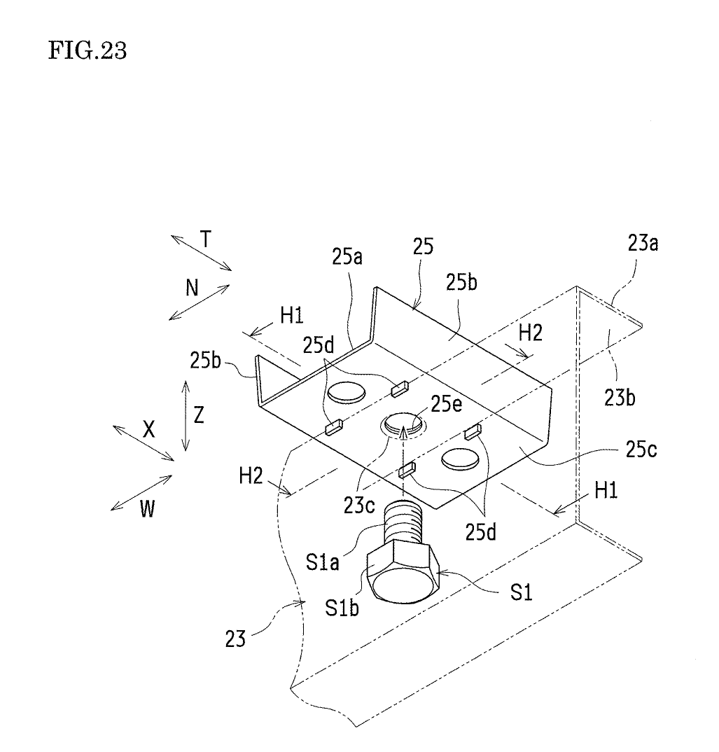

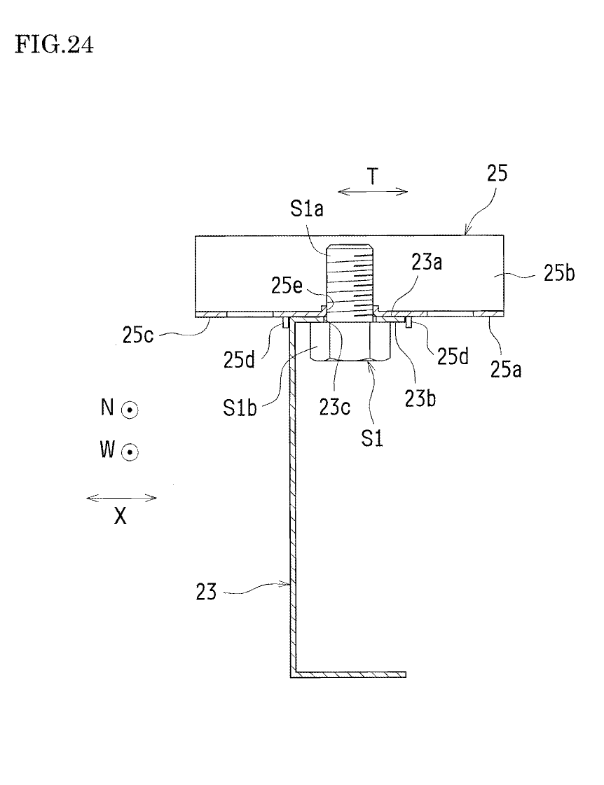

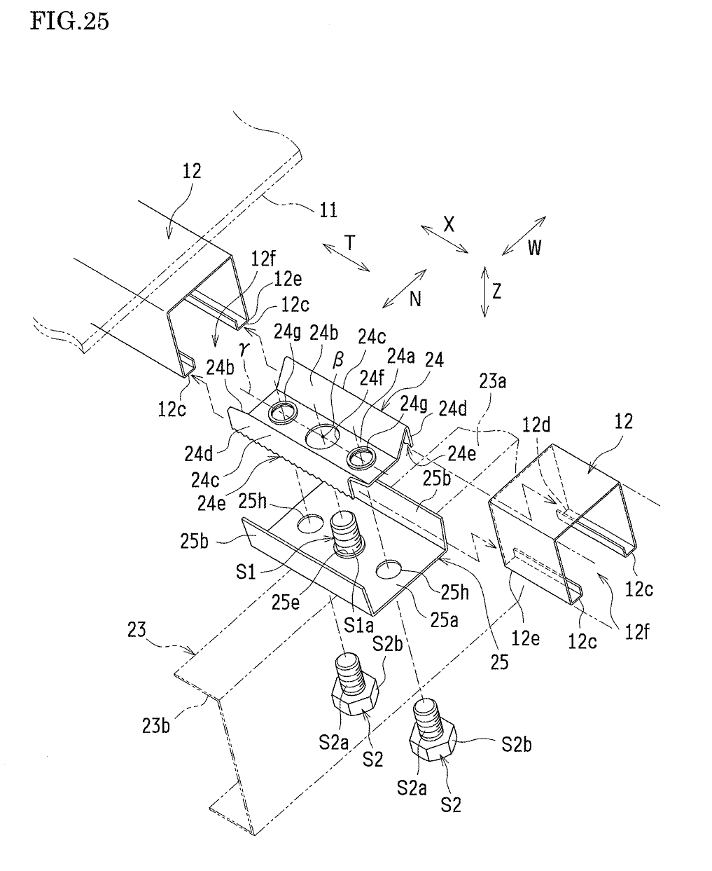

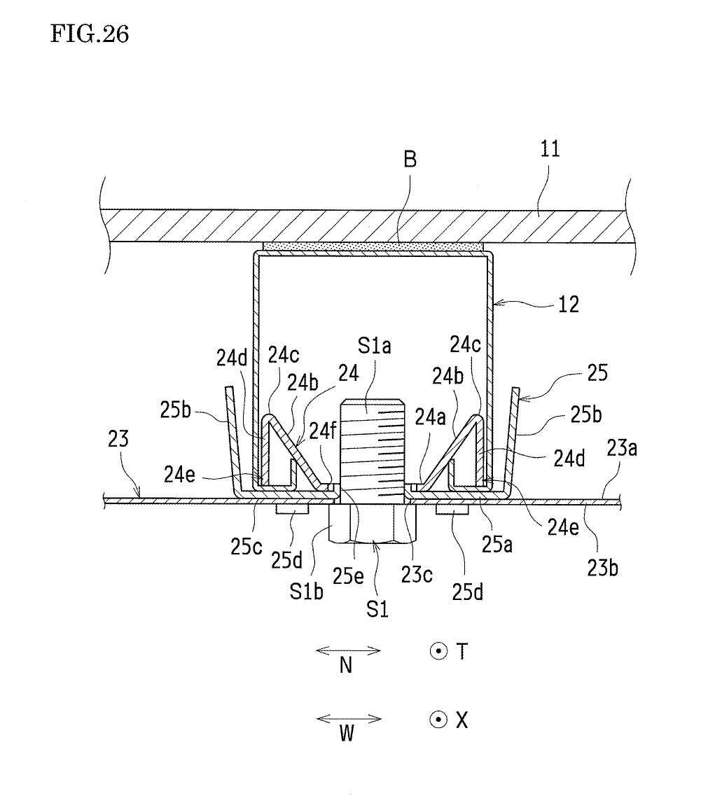

FIG. 23 is a schematic perspective view of the state in which the receiving part 25 is mounted on and fixed to the longitudinal bar 23, when viewed from diagonally below. FIG. 24 is a schematic sectional view along an H1-H1 line in FIG. 22 and FIG. 23 depicting the state in which the receiving part 25 is mounted on and fixed to the longitudinal bar 23. FIG. 25 is a schematic exploded perspective view of the state in which installation ends 12e, 12e of support rails 12, 12 that are adjacent to each other in a lateral direction X with respect to the receiving part 25 fixed to the longitudinal bar 23 abut on each other to be fixed with a fixture 24, when viewed from diagonally above. FIG. 26 is a schematic sectional view along an H2-H2 line in FIG. 22 and FIG. 23 depicting the state in which the installation ends 12e, 12e of the support rails 12, 12 that are adjacent to each other in the lateral direction X with respect to the receiving part 25 fixed to the longitudinal bar 23 abut on each other to be fixed with the fixture 24.

As depicted in FIG. 22 to FIG. 26, a through hole 23c letting a male screw S1 pass therethrough is provided at a position where the receiving part 25 of the upper side plate 23b configuring the mount tilted surface 23a of the longitudinal bar 23 is provided.

The receiving part 25 has an installation plate 25a to be provided on the mount tilted surface 23a of the longitudinal bar 23 and side plates 25b, 25b folded upward at ends on both sides of the installation plate 25a in the up-down tilt direction W. The installation plate 25a is provided with a female screw hole 25e in which a screw part S1a of the male screw S1 is screwed. The through hole 23c of the longitudinal bar 23 has a size larger than the female screw hole 25e of the receiving part 25 in which the male screw S1 is screwed and smaller than the size of a head part S1b of the male screw S1. According to this structure, with the receiving part 25 as being arranged on the upper side plate 23b of the longitudinal bar 23, the male screw S1 passes through the through hole 23c from a lower side of the side plate 23b to be screwed into the female screw hole 25e of the receiving part 25. With this, the receiving part 25 is reliably fixed to the upper side plate 23b of the longitudinal bar 23.

In more detailed description, a bottom surface 25c of the installation plate 25a (refer to FIG. 23, FIG. 24, and FIG. 26) is provided with regulation ribs 25d (refer to FIG. 23, FIG. 24, and FIG. 26) which allow the movement of the receiving part 25 in the up-down tilt direction W and, on the other hand, regulate the movement of the receiving part 25 in the lateral direction X. The regulation ribs 25d are provided in the lateral direction X with a space similar to the width of the upper side plate 23b in the longitudinal bar 23 in the lateral direction X. The female screw hole 25e is positioned between the regulation ribs 25d to 25d provided so as to be spaced apart from each other in the lateral direction X. According to this structure, with the receiving part 25 as being arranged on the upper side plate 23b of the longitudinal bar 23 and regulated in movement to the lateral direction X by the regulation ribs 25d to 25d, the male screw S1 passes through the through hole 23c of the side plate 23d from the lower side of the side plate 23d to be screwed into the female screw hole 25e of the receiving part 25. With this, the receiving part 25 is reliably fixed to the upper side plate 23b of the longitudinal bar 23. Specifically, the regulation ribs 25d to 25d are provided so as to be spaced apart from each other also in the up-down tilt direction W. Here, the regulation ribs 25d to 25d are provided at two locations in the lateral direction X and the two locations in the up-down tilt direction W, and therefore four locations in total. The female screw hole 25e is positioned at the center of a point of intersection of diagonal lines passing through the regulation ribs 25d to 25d at four locations. With this, the through hole 23c in the upper side plate 23b of the longitudinal bar 23 and the female screw hole 25e in the installation plate 25a of the receiving part 25 can be easily positioned, and mounting workability can be improved accordingly.

As depicted in FIG. 25 and FIG. 26, the fixture 24 has a bottom plate 24a, tilted plates 24b, 24b with facing two sides of the bottom plate 24a in the up-down tilt direction W folded diagonally upward and outward, and side plates 24d, 24d with upper sides 24c, 24c of the tilted plates 24b, 24b folded downward. The fixture 24 with the above-described structure can be formed by stamping and folding a steel plate and then plating its surface. In the present embodiment, a lower end 24e of each of the side plates 24d, 24d is formed in a shape of many triangular mountains (a triangular teeth shape) along the lateral direction X. With this, the installation ends 12e, 12e of the support rails 12, 12 can be reliably held and fixed to the receiving part 25.

Also, the bottom plate 24a of the fixture 24 is provided with a through hole 24f letting a screw part S1a of the male screw S1 pass therethrough. The bottom plate 24a of the fixture 24 is also provided with two female screw holes 24g, 24g (refer to FIG. 25) at symmetrical positions on both sides in the lateral direction X via the through hole 24f, the female screw holes 24g, 24g in which two male screws S2, S2 are screwed.

On the other hand, the receiving part 25 is provided with two through holes 25h, 25h (refer to FIG. 25) at symmetrical positions on both sides in the lateral direction X via the female screw hole 25e, the through holes 25h, 25h letting screw parts S2a, S2a of two male screws S2, S2 to be screwed in the two female screw holes 24g, 24g provided to the fixture 24 pass therethrough. These two through holes 25h, 25h each have a size larger than each of the two female screw holes 24g, 24g and smaller than each of the head parts S2b, S2b of the two male screws S2, S2. According to this structure, with the fixture 24 mounted on the installation ends 12e, 12e of the support rails 12, 12 that are adjacent to each other in the lateral direction X, the installation ends 12e, 12e mounted on the installation plate 25a of the receiving part 25 and abutting on each other, the two male screws S2, S2 pass through the two through holes 25h, 25h of the receiving part 25 and are screwed in the two female screw holes 24g, 24g of the fixture 24. Thus, with the fixture 24 fixed to the receiving part 25, the installation ends 12e, 12e of the support rails 12, 12 that are adjacent to each other in the lateral direction X can be reliably fixed to the receiving part 25.

In more detailed description, the two female screw holes 24g, 24g are positioned so that their centers are positioned on both sides of a center β (refer to FIG. 25) of the through hole 24f in the lateral direction X and on a virtual straight line γ (refer to FIG. 25) passing through the center β in parallel with the lateral direction X. The distance between one female screw hole 24g and the center β of the through hole 24f and the distance between the other female screw hole 24g and the center β of the through hole 24f is assumed to be equal to each other.

In the present embodiment, the plurality of solar cell module bodies 11 are linked in parallel with each other, and the support rails 12, 12 are bonded to the back surface of the plurality of solar cell module bodies 11 to 11 via the adhesives 30 to 30. With this, an increase in size of the sub-unit 10 can be achieved with a simple structure.

And, when the sub-units 10 to 10 are installed, with the sub-units 10, 10 that are adjacent to each other arranged adjacently approximately without a space, an operation of fixing the installation ends 12e, 12e of each of the support rails 12 to 12 to the mounting 20 with the fixture 24 through the gap provided between the installation plate 25a of the receiving part 25 and the back surface of each of the solar cell module bodies 11 to 11 can be performed. With this, with the sub-units 10, 10 that are adjacent to each other arranged adjacently approximately without a space, adjacent sub-units 10, 10 can be reliably fixed. Therefore, while the space between adjacent sub-units 10, 10 is saved, power generation efficiency can be increased. Also, on the back surface side of each of the sub-units 10, 10, strength of the fixture 24 and the mounting 20 can be kept without particularly restricting the size and the like of the fixture 24 and the mounting 20. With this, a stable support structure and support strength for the sub-units 10 to 10 can be ensured.

Note that an operation of mounting the fixture 24 from the back side onto the installation ends 12e, 12e of the support rails 12, 12 that are adjacent to each other in the lateral direction X mounted on the installation plate 25a of the receiving part 25 to abut on each other can be performed as follows.

That is, near the installation end 12e of one support rail 12 mounted on the receiving part 25, from an opening 12f (refer to FIG. 8, FIG. 11, and FIG. 25) surrounded by the folded reinforcing parts 12c, 12c of the support rail 12 and open downward, the fixture 24 is inserted into the opening 12f by being diagonally tilted or rotated at 90° as being along the longer direction (lateral direction X) of the support rail 12, the fixture 24 is returned to its original posture in the support rail 12, and is then moved in the lateral direction X to be positioned on the receiving part 25. By causing the through hole 24f of the fixture 24 to fit in the screw part S1a of the male screw S1 screwed in the female screw hole 25e of the receiving part 25 to project upward, the fixture 24 can be mounted on the receiving part 25 (more accurately, the side plates 24d, 24d of the fixture 24 can be mounted on the inner surfaces of the folded reinforcing parts 12c, 12c of the installation ends 12e, 12e of the support rails 12, 12).

With this, the positions of the two female screw holes 24g, 24g of the fixture 24 and the positions of the two through holes 25h, 25h of the receiving part 25 are approximately matched with each other. Subsequently, screw parts S2a, S2a of the two male screws S2, S2 are caused to pass through the two through holes 25h, 25h of the receiving part 25 from a lower side of the receiving part 25 to be screwed in the two female screw holes 24g, 24g of the fixture 24, and the installation ends 12e, 12e of the support rails 12, 12 can be fixed to the receiving part 25, that is, the longitudinal bar 23.

Also, the installation end 11d on a side where any sub-unit 10 is not present next in the lateral direction X of the support rail 12 (at an ending end position) is fixed to the receiving part 25 by mounting only the installation end 11d at the ending end position of the support rail 12 on the receiving part 25 with the fixture 24.

By using the above-described scheme, the solar power generation system A with the plurality of sub-units 10 mounted and fixed onto the mounting 20 can be constructed.

Note that the embodiment disclosed this time is illustrated by way of example in all points, and does not serve as a base for limited interpretation. Therefore, the technical scope of the present invention is not interpreted only based on the above-described embodiment, but is demarcated based on the description of the scope of claims for patent. Also, the present invention includes meanings equivalent to the scope of claims for patent and all changes within the scope.

### REFERENCE SIGNS LIST

A solar power generation system

10 solar cell module (sub-unit)

11 solar cell module body

11a solar cell group

11b light-receiving-surface glass

11c back surface glass

12, 13 support rail (support member)

12a, 13a main plate

12a1, 13a1 upper surface (adhesive surface)

12a2, 13a2 opposite surface

12b, 13b side plate

12c, 13c folded reinforcing part

12d hole (check hole)

12d1 inner circumferential surface

12d11 circumferential edge part

12e installation end

12f opening

20 mounting

21 base

22 arm member

23 longitudinal bar

23a mount tilted surface

23c through hole

25 receiving part

25a installation plate

25b side plate

25c bottom surface

25d regulation rib

25e female screw hole

30 adhesive (adhesive member)

40 spacer member

210 coating device

210a coating part

210c moving part

211 adhesive accommodating part

211a accommodation tank

211b first tank

211c second tank

212 adhesive supply part

213 adhesive discharge part

213a nozzle

220 mounting device

222 mount roller part

222a mount roller

222a1 rotating shaft

222a2 fitting groove part

222b support frame

222c bearing

222b support frame

230 support member

231 mobile carriage

240 holding member

S1, S2 male screw

S1a, S2a screw part

S1b, S2b head part

1. A solar cell module comprising a solar cell module body, an adhesive member, and a support member bonded and fixed by the adhesive member to a back surface of the solar cell module body,
wherein a spacer member for ensuring a thickness of the adhesive member is arranged between the back surface of the solar cell module body and an adhesive surface of the support member.

2. The solar cell module according to claim 1,
wherein a plurality of the support members in a long shape are arranged in parallel with each other with a predetermined space, and
a plurality of the solar cell module bodies are provided as being bridged over each of the support members to be bonded and fixed to each of the support members.

3. The solar cell module according to claim 1,
wherein the spacer members are arranged with respect to the solar cell module body at a plurality of locations in a longer direction of the support member.

4. The solar cell module according to claim 3,
wherein the spacer members are arranged at both ends of the solar cell module body.

5. The solar cell module according to claim 4,
wherein the spacer member is arranged at one or plurality of locations along the longer direction between the both ends of the solar cell module body.

6. The solar cell module according to claim 1,
wherein the spacer member is a double-sided adhesive tape.

7. The solar cell module according to claim 1,
wherein the adhesive member is provided so as to run over from one side or both sides of the adhesive surface of the support member along the longer direction.

8. The solar cell module according to claim 1,
wherein a hole penetrating through a surface opposite to the adhesive surface is provided in the adhesive surface of the support member.

9. The solar cell module according to claim 8,
wherein the adhesive member is provided so as to be immersed into the hole and cover at least an inner circumferential surface of the hole.

10. The solar cell module according to claim 8,
wherein the holes are provided at a plurality of locations along the longer direction of the support member.

11. A production method for a solar cell module including a solar cell module body, a support member supporting the solar cell module body, and an adhesive member bonding and fixing the support member onto a back surface of the solar cell module body, the method comprising:
a step of arranging a spacer member for ensuring a thickness of the adhesive member on either one of an adhesive region on a back surface side of the solar cell module body where the support member is bonded and
an adhesive region of the adhesive surface of the support member;
a coating step of coating, with the adhesive member, either one of the adhesive region on the back surface side of the solar cell module body where the support member is bonded and the adhesive region of the adhesive surface of the support member; and
a laminating step of laminating the adhesive region on the back surface side of the solar cell module body and the adhesive region of the support member to bond the solar cell module body and the support member together.

12. The solar cell module production method according to claim 11,
wherein, in the coating step, the adhesive member is provided so as to run over from one side or both sides of the adhesive surface of the support member along the longer direction.

13. A support structure for the solar cell module according to claim 1, the structure comprising:
a mounting where an end of the support member bonded to the solar cell module is mounted; and
a fixing part which fixes the end to the mounting.

14. A solar cell module support structure for supporting a plurality of the solar cell modules according to aligned thereon, the structure comprising:
a mounting where ends which are adjacent to each other of the support member of the solar cell modules which are adjacent to each other are mounted; and
a fixing part which fixes the ends which are adjacent to each other to the mounting.

15. A solar power generation system using the solar cell module support structure according to claim 13.
